(19) United States
(12) Patent Application Publication
(10) Pub. No.: US 2013/0307779 A1
(43) Pub. Date: Nov. 21, 2013

(54) SYSTEMS, METHODS, AND DEVICES FOR ELECTRONIC COMMUNICATION

(71) Applicants: William Towell, Madison, WI (US); Ian Purvis, Guttenberg, IA (US)

(72) Inventors: William Towell, Madison, WI (US); Ian Purvis, Guttenberg, IA (US)

(73) Assignee: Bad Donkey Social, LLC, Madison, WI (US)

(21) Appl. No.: 13/828,234

(22) Filed: Mar. 14, 2013

Related U.S. Application Data
(60) Provisional application No. 61/648,387, filed on May 17, 2012.

(51) Int. Cl. G06F 17/24; G06F 3/02

(52) U.S. Cl. CPC G06F 17/24; G06F 3/02
USPC 345/168; 704/270

(57) ABSTRACT

A system for communicating over a communication network(s) is disclosed. The system includes software operated on a user device in the communication network(s), and is adapted to store, receive, display, and send or submit alphanumeric data and user-driven non-alphanumeric content. The system includes a data selection area on the user device in communication with the software for selection of alphanumeric data and user-driven non-alphanumeric content for display. A display is provided on the user device for the display of the alphanumeric data and the user-driven non-alphanumeric content. The display is in communication with the software on the user device, the software being adapted to display the alphanumeric data with inline user-driven non-alphanumeric content in a software application operated by the user device. The software is also adapted to communicate and receive the alphanumeric data and user-driven non-alphanumeric content over the communication network(s) for display.

### CROSS-REFERENCE TO RELATED APPLICATIONS

This application claims priority to U.S. Provisional Patent Application Ser. No. 61/648,387, filed May 17, 2012, entitled “SYSTEMS, METHODS AND DEVICES INCLUDING INTERFACE PROTOCOL MODEL AND COMMUNICATION MEDIUM,” the entire contents of which is hereby incorporated by reference in its entirety herein.

### FIELD

The inventions disclosed herein relate to a communication system, and in particular, to a communication system for a portable electronic device.

### BACKGROUND

Most adults and teens, and even children, today own a portable electronic device. Many of these individuals rely on messaging, email, and social media to communicate via electronic device.

As a result, the volume of messaging is rapidly increasing. Social media and networking are also rapidly increasing in popularity. A social network is, generally, an application or service that facilitates the building of online communities of people who communicate, share interests, and publish content. Many social networks are web-based, but also linked through portable electronic devices. Examples of commonly used social networks today include FACEBOOK, LINKEDIN, and TWITTER, although there are an ever-increasing number of such networks targeted to specific and broad-based interests.

These communication tools provide a number of mechanisms or platforms for users to interact, including for example, instant messaging, email, posts, tweets, and the like. While there are many advantages to these non-verbal communication tools, there are limitations. Text messaging, in particular, limits the number of characters and content that can be used to communicate. Likewise, some such social networks (e.g., TWITTER) limit the number of characters that can be included in a message, post, or tweet.

Many portable electronic devices today rely on alphanumeric text for text messaging and other non-verbal communication functions, such as social media posts and email. Some such devices also permit the messaging and/or posting of photographs or images taken or stored locally on the mobile device. However, such devices and the software systems they operate send these images as attachments outside of text and are not capable of integrating these images inline with the message text.

Emoji or emoticons are available on some electronic devices and used in electronic communications. Emoticons are standardized symbols defined within the Unicode character encoding set. As is known, Unicode is a computing industry standard for the consistent encoding, representation, and handling of text expressed in various world writing systems. Therefore, not only are emoticons limited to that which is predefined by the standard and supported by a particular device/implementation/vendor, but emoticons are text-based (as a result of Unicode) and limited to the scope of Unicode character representation and/or limited due to the inherent restrictions of the Unicode character set (size of the set, number of characters representable, etc.). As a text-based language, communications involving emoticons are based in predefined alphanumeric characters and are, therefore, limited.

### SUMMARY

Accordingly, a system for communicating over a communication network(s) is disclosed. The system includes software operated on a user device in the communication network(s). The software is adapted to store, receive, display, and send or submit alphanumeric data and user-driven non-alphanumeric content. A means to obtain the user-driven non-alphanumeric content and a storage system in communication with the software on the user device for the storage of data, including the user-driven non-alphanumeric content, are also provided. The system also includes a data selection area on the user device which is in communication with the software for selection of alphanumeric data and the selection of user-driven non-alphanumeric content for display. A display is provided on the user device for the display of the alphanumeric data and the user-driven non-alphanumeric content. The display is in communication with the software on the user device, the software being adapted to display the alphanumeric data with inline user-driven non-alphanumeric content in a software application operated by the user device. The software is also adapted to communicate and receive the alphanumeric data and user-driven non-alphanumeric content over the communication network(s) for display.

A method for the display of integrated data is also disclosed. The method includes providing software operated on a user device having a display and in communication with a communication network(s). The software is in communication with systems for storage, receipt, display, and submission of alphanumeric data and user-driven non-alphanumeric content. The method also includes obtaining user-driven non-alphanumeric content, and operating the user device to implement the software so as to display alphanumeric data with inline user-driven non-alphanumeric content in a software application operated by the user device.

A data selection device or keyboard interface for a portable electronic device having a display is also disclosed. The data selection device has a plurality of inputs including alphanumeric data in a qwerty arrangement in a first area, and a plurality of inputs including user-driven non-alphanumeric content in a second area. The second area is displayed simultaneously with the first area. Less than all of the plurality of inputs including user-driven non-alphanumeric content are displayed simultaneously. The display of the plurality of inputs including user-driven non-alphanumeric content is changeable by a movement of the displayed plurality of inputs including user-driven non-alphanumeric content relative to the first area.

Accordingly, an innovative new social communication platform is provided that enhances communication on digital devices. The technology includes a software system, and in one or more examples of embodiments a data selection device or keyboard interface that function(s) to integrate alphanumeric data with inline user-driven non-alphanumeric content to create a new cyber language.

These and other features and advantages of devices, systems, and methods according to this invention are described in, or are apparent from, the following detailed descriptions of various examples of embodiments.

### BRIEF DESCRIPTION OF DRAWINGS

Various examples of embodiments of the systems, devices, and methods according to this invention will be described in detail, with reference to the following figures, wherein:

FIG. 1 is a flow chart illustrating one or more examples of a communication system described herein.

FIG. 2 is a flow chart illustrating one or more examples of a content management system for the communication system.

FIG. 3 is a flow chart illustrating one or more examples of embodiments of a data-editing system for the communication system, showing editor and data interaction to compose a communication of alphanumeric data with inline user-driven non-alphanumeric content.

FIG. 4 is a screen shot of one or more examples of the system, method, and/or devices for communication described herein, including a communication being composed to be submitted/sent and a communication received having alphanumeric data integration with inline user-driven non-alphanumeric content, and a keyboard interface.

FIG. 5 is a logic flow chart illustrating one or more examples of predictive content functionality for use with the communication system.

FIG. 6 is a flow chart illustrating one or more examples of integration and/or interaction of the communication system with one or more third-party system(s).

FIG. 7 is a screen shot of one or more examples of the system, method, and/or devices for communication described herein, showing a device having the keyboard interface for composing integrated alphanumeric data with inline user-driven non-alphanumeric content, and a display.

FIG. 8 is a screen shot of one or more examples of the device illustrated in FIG. 7, showing a subfile system for use with the communication system.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

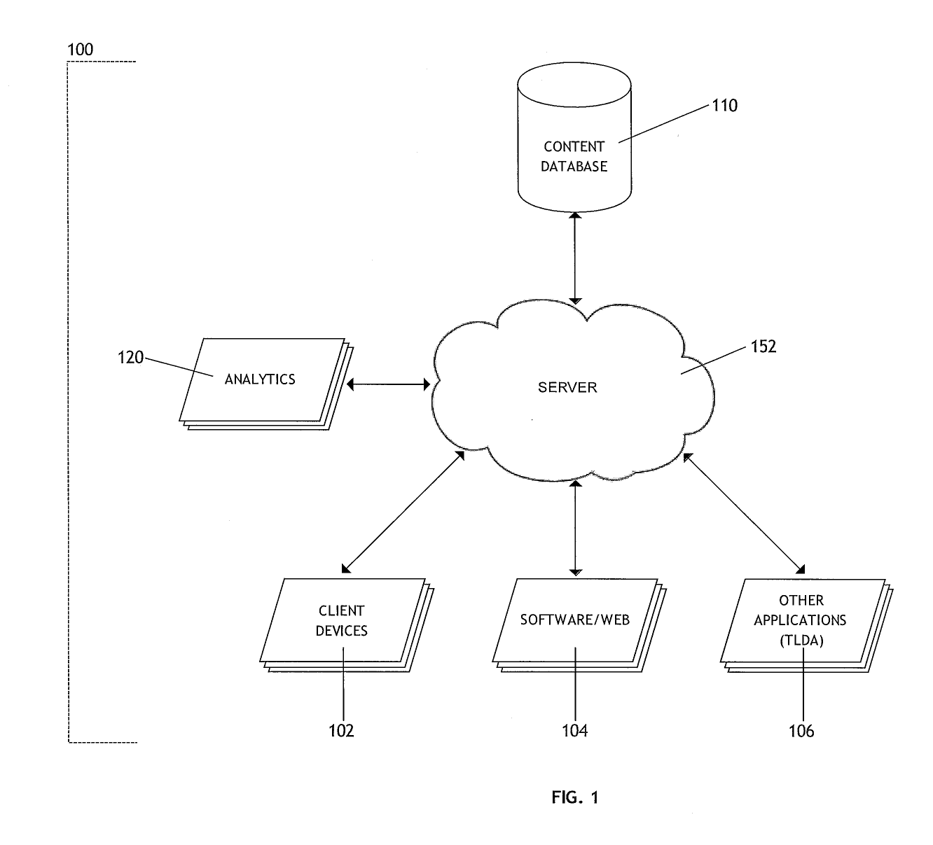

In one or more examples of embodiments, a communication system forming an interface protocol model that provides a mechanism by which to integrate alphanumeric data with inline user-driven non-alphanumeric content or data to create a new cyber language is provided (FIG. 1). The software system may also form a social communication platform, as well as other applications, such as text, email, messaging, posts, tags, comments, word documents, and the like. The system described herein is adapted for use with a user device, such as a portable electronic device, personal computer, and/or other digital devices.

The systems, methods, and devices described herein may be used or implemented on or with various now known and/or future developed technology platforms and applications. Examples of technology applications which may use the system, method, and devices described herein include, but are not limited to, text messaging, email, chat, instant messaging, social media, posts, tweets, personal messages, blogs, tags, comments, word documents, and the like.

Accordingly, a system for communicating over a communication network(s) is disclosed. As shown in FIG. 1, the system technology architecture generally includes a software platform 100 facilitating the integration of alphanumeric data and inline user-driven non-alphanumeric content within written script. The technology architecture links this system to a plurality of platforms. For example, the system may be implemented on or in connection with one or more user/client devices 102, such as a personal computer and/or a mobile device or portable electronic device. The system may also be implemented on or in connection with software and a website 104 (or provide services therefore), as well as on or in connection with other applications 106 (or provide services therefore), such as one or more existing or future developed third-party platforms which include communication vehicles (e.g., FACEBOOK, LINKEDIN, TWITTER, and the like). The technology architecture also links the software system 100, and thus the various connected platforms, to a database, namely a content database 110 for the storage and retrieval of content developed or obtained, by or through the system. The system may also be linked to an analytic function 120 for various purposes including, but not limited to, the tracking of various operations performed by system users (or provide services therefore).

The system includes software operated on a user device in the communication network(s). The software is adapted to store, receive, display, and send or submit alphanumeric data and user-driven non-alphanumeric content. A means to obtain the user-driven non-alphanumeric content and a storage system in communication with the software on the user device for the storage of data, including said user-driven non-alphanumeric content, are also provided. The system also includes a data selection area on the user device which is in communication with the software for selection of alphanumeric data and the selection of user-driven non-alphanumeric content for display. A display is provided on the user device for the display of the alphanumeric data and the user-driven non-alphanumeric content. The display is in communication with the software on the user device, the software being adapted to display the alphanumeric data with inline user-driven non-alphanumeric content in a software application operated by the user device. The software is also adapted to communicate and receive the alphanumeric data and user-driven non-alphanumeric content over the communication network(s) for display.

As detailed herein, user-driven non-alphanumeric content is captured, obtained, received, or transmitted by the user device. Non-alphanumeric content is provided in or encoded in binary form. Accordingly, the non-alphanumeric content may contain any type of data for storage, processing, and/or communication purposes. Further, as noted, the non-alphanumeric content is user-driven. Accordingly, the content is selected and communicated by the user, and may be continuously or infinitely updated. Examples of user-driven non-alphanumeric content suitable for use with the system described herein may include, but are not limited to, pictures, images, logos, custom graphics, video, audio, geographic information, and/or other information and content (in suitable file formats for use by the system). In one or more specific examples of embodiments, data used by the software system is in the form of binary code. In one or more further examples of embodiments, the non-alphanumeric content is digital content, and in particular is user-driven content (e.g., content about or selected by the user).

According to one or more examples of embodiments, a data structure, such as an interface standard, may be provided for the holding and transferring of content between devices, as well as between devices and a server. For example, the data structure may be, but is not limited to, uuencoded elements in an XML structure or JSON structure or similar. The structure itself may also be serialized and encoded. However, it is also contemplated that a public domain multimedia, such as for example, a MIME type structure may be used without departing from the overall scope of the present invention, and specific languages identified herein are provided for purposes of example only.

User-driven non-alphanumeric content may be obtained by a variety of means. For example, a content database may be provided which has or contains user-driven non-alphanumeric content, wherein the software is in communication with the content database and may select for display (or deliver for storage and later selection/display) user-driven non-alphanumeric content. In one or more alternative or additional examples of embodiments, user-driven non-alphanumeric content may be obtained by an image forming or capturing device, such as but not limited to, a camera. In one or more further examples of embodiments, the user-driven non-alphanumeric content is imported into the communication system by the portable electronic device (e.g., photos, screen shots, website content, and the like). Content may be available from any number of sources, such as but not limited to, a portable electronic device camera, a digital library, connected servers, a digital camera, and the like. To this end, the software is in communication with the image forming or capturing device to retrieve and subsequently store the user-driven non-alphanumeric content obtained by the device. In one or more additional and/or alternative examples of embodiments the user-driven non-alphanumeric content may be stored locally on the user device and retrieved by the software system. Content may also be obtained by a copy-and-paste function into an editor carried by the device. In additional examples of embodiments, content may be uploaded by use of; and/or uploaded to, a personal computer or website.

Accordingly, a content management system may be used by the communication system. In one or more examples of embodiments, a communication link to a content database is provided. The content database may be provided in communication with one or more servers which, in some examples of embodiments, may be cloud-based computing servers; however, traditional servers may also be acceptable. For example, the user-driven non-alphanumeric content may be obtained and/or sent via closed-loop servers, including for example, cloud-based servers. As shown in FIG. 1, the content database 110 is in communication with a server 152 for the exchange of information or data over one or more network(s).

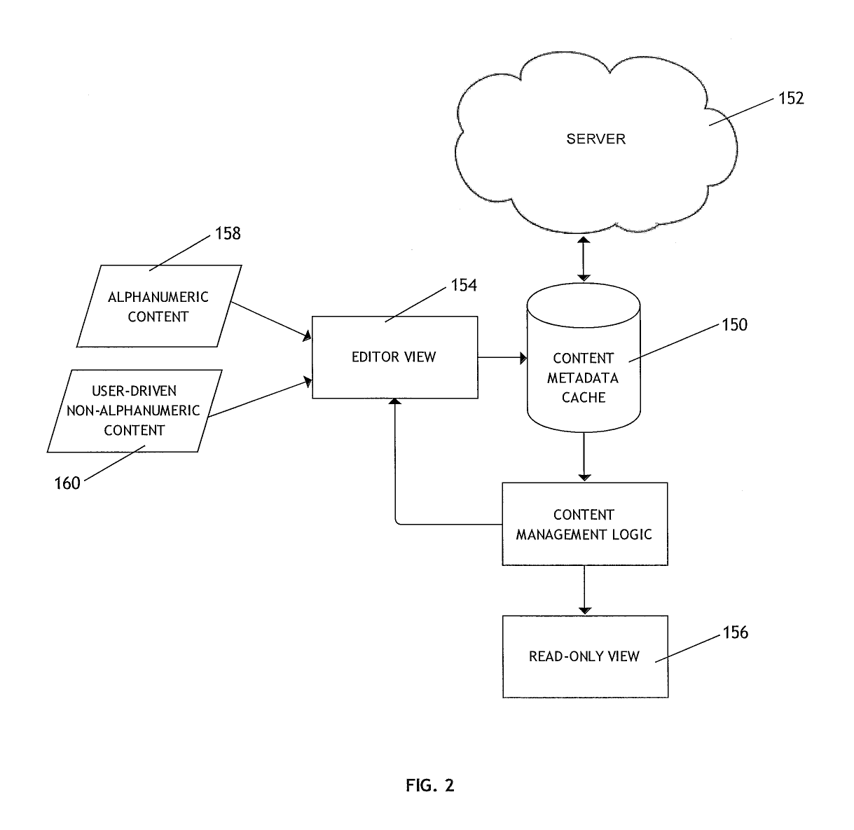

As shown in FIG. 2, the server 152 may also be in communication with a local content database 150, such as may be present on a user/client device 102 (FIG. 1). The client device may include a local cache database 150 for local content storage. As illustrated in FIG. 2, the client application is in communication with the server 152 for storing data in the local cache database 150. The local content database 150 may include user-driven non-alphanumeric content, as well as metadata and cached data.

Alphanumeric content or data 158 and user-driven non-alphanumeric content 160 may also be obtained by the editor 154. Accordingly, the content management system may implement content management logic to obtain selected content, or for example, determine the source for the selected content. In one or more examples of embodiments, content management logic may be customized for one or more specific applications or platforms of the communication system. In this regard, any logic suitable for use by the application or platform may be inserted or defined by the implementer for use with the communication system. Database content may also be managed using logic to distribute content for editing (e.g., in an editor view module 154) or to distribute content for viewing (e.g., in a read-only view module 156). The editor module 154 may also be in communication with the content database to deliver edited or obtained content to the database 150.

The content database(s) 110 (FIGS. 1) and 150 include user-driven non-alphanumeric content obtained from one or more sources and, in one or examples of embodiments may include alphanumeric data. Moreover, one or more clients, for example users with mobile devices or portable electronic devices 102 (FIG. 1) and/or personal computer users, are in communication with the server 152 for the exchange or transfer, submission, and retrieval of data—which data may be retrieved from or sent by the content database 110 (FIG. 1) and/or 150 to the server 152 and subsequently to the connected devices 102 (FIG. 1).

In one or more examples of embodiments the system and/or method may be implemented by a computer system or in combination with a computer system. The computer system may be or include a processor. The computers may be portable electronic devices for use with the methods and various components described herein and may be programmable computers which may be special purpose computers or general purpose computers that execute the system according to the relevant instructions. The computer system or portable electronic device can be an embedded system, a personal computer, notebook computer, server computer, mainframe, networked computer, workstation, handheld computer, as well as now known or future developed mobile devices, such as for example, a personal digital assistant, cell phone, smartphone, tablet computer, and the like. Other computer system configurations are also contemplated for use with the communication system including, but not limited to, multiprocessor systems, microprocessor-based or programmable electronics, network personal computers, minicomputers, smart watches, and the like. Preferably, the computing system chosen includes a processor suitable in size to efficiently operate one or more of the various systems or functions or attributes of the communication system described.

The system or portions thereof may also be linked to a distributed computing environment, where tasks are performed by remote processing devices that are linked through a communication network(s). To this end, the system may be configured or linked to multiple computers in a network including, but not limited to, a local area network, wide area network, wireless network, and the Internet. Therefore, information, content, and data may be transferred within the network or system by wireless means, by hardwire connection, or combinations thereof. Accordingly, the servers described herein communicate according to now known or future developed pathways including, but not limited to, wired, wireless, and fiber-optic channels.

Data may be sent or submitted via the Internet, wireless, and fiber-optic communication network(s), or created or stored on a particular device. In one or more examples of embodiments, alphanumeric data, user-driven non-alphanumeric content, message or communication data, and other data, such as but not limited to, analytic or usage data may be stored. In one or more examples of embodiments, data may be stored remotely or may be stored locally on the user's device. In one example, data may be stored locally in files, such as but not limited to, data stored by an app. However, data may also be stored remotely and retrieved by the app. Locally created content or data, such as but not limited to, photos, images, audio, and video, may also be used and stored.

Data may be stored and transmitted by and within the system in any suitable form. Any source code or other language suitable for accomplishing the desired functions described herein may be acceptable for use.

Furthermore, the computer or computers or portable electronic devices may be operatively or functionally connected to one or more mass storage devices, such as but not limited to, a database. The memory storage can be volatile or non-volatile, and can include removable storage media. Cloud-based storage may also be acceptable. The system may also include computer-readable media which may include any computer-readable media or medium that may be used to carry or store desired program code that may be accessed by a computer. The invention can also be embodied as computer-readable code on a computer-readable medium. To this end, the computer-readable medium may be any data storage device that can store data which can be thereafter read by a computer system. Examples of computer-readable medium include read-only memory, random-access memory, CD-ROM, CD-R, CD-RW, magnetic tapes, flash drives, as well as other optical data storage devices. The computer-readable medium can also be distributed over a network-coupled computer system so that the computer-readable code is stored and executed in a distributed fashion.

The portable electronic device, software system and keyboard interface further operate and integrate with a user's personal computer. In one or more examples of embodiments, the user's personal computer may act or operate as a “server” storing one or more data files (e.g., user-driven non-alphanumeric content) for use by the software system and keyboard interface. For example, user-driven content may be retained by and obtained from the user's personal computer. The personal computer may also utilize an Internet-connected website, provided to manage one or more functions of the software system, cyber language, and keyboard interface operated by the portable electronic device, and the user-driven non-alphanumeric content. In other words, the portable electronic device, software application, keyboard interface, personal computer, and website may be integrated for use.

The computer or portable electronic device can also include a display, provision for data input and output, etc. For example, these devices include a graphical user interface (GUI) or a communication means by which commands may be entered and content may be displayed or communicated. The computer or portable electronic device includes a user interface that allows navigation of objects. The computer or portable electronic device implements or includes an application that enables a user to display and interact with communications including alphanumeric data as well as user-driven non-alphanumeric content, other information, and content.

Aspects of the method described herein are implemented on a software system running on a computer system. To this end, the methods and system may be implemented in, or in association with, a general purpose software package or a specific purpose software package.

The software system described herein may include a mixture of different source codes. The system or method herein may be operated by computer-executable instructions, such as but not limited to, program modules, executable on a computer. Examples of program modules include, but are not limited to, routines, programs, objects, components, data structures, and the like which perform particular tasks or implement particular instructions. The software system may also be operable for supporting the transfer of information within a network.

In one or more examples of embodiments, the system described herein, and/or portions thereof, may be implemented in a web-based platform or website platform or a device application (“app”) platform, or a combination or integration of web and mobile app or application platform or structure. The software application may be, for example, a mobile device app having an integrated website. In one particular example of a mobile application, the system may operate within a closed-loop server system. In this example, the application and a linked website integrate with closed-loop servers using supporting source code. Any source code capable of supporting the functions described herein may be suitable for the purposes provided. The servers may facilitate the storage of data, such as alphanumeric and user-driven non-alphanumeric content, and synchronize the application and web content libraries, in/out message boxes, push notifications, software updates, and other data and/or features, such as user usage analytics, data related to marketing and advertising programs, and the like. The portable electronic devices or Internet-connected devices also communicate with the servers to exchange the referenced data, including the transfer of data associated with each message created by the users.

An integrated file system may also be provided which allows users to manage, select, create, and import personally selected user-driven non-alphanumeric content, or user-driven personal content, into a message having alphanumeric data integrated with inline user-driven non-alphanumeric content. Various examples of file structures and categories are acceptable for use with the integrated file system. Representative illustrative examples include, but are not limited to, logo files which may include the following categories: clothing, personal care, school, stores, restaurants, food and beverage, sports, music, art, entertainment, follow, Internet, transportation, and other; picture files which may include the following categories: instant and archived; custom files which may include categories that are created by the user; and/or custom graphic image files.

The software system also interfaces with server databases to help serve or deliver data or content related to user-driven non-alphanumeric content to the user or to the recipient of a message containing user-driven non-alphanumeric content. Examples include, but are not limited to, a coupon or an advertisement associated with content, such as for example, a brand or logo. That is, as an illustrative example, a company's digital content may be provided in association with a company link, coupon, phone number, offer, or other useful company information, such that the digital content may have a marketing or social image value for the company. As a result of this association, if a user selects a company link, the link and associated company information are placed inline in the cyber language which is communicated by the user. A communication recipient views the company content, but also may select the inline content, and language or content is then provided to the recipient with the company's communication or associated information, providing a very direct and targeted communication. As a result, a user or recipient does not need to go to a company's website or other website to gain this same information.

In one or more examples of embodiments, a user analytic module 120 (FIG. 1) and/or feedback module may also be provided in association with the software system. For example, data on any number of attributes of usage of the user-driven non-alphanumeric content, representative examples of which include downloads, selection rates, and user behavior, may be monitored, tracked, obtained, collected, and/or analyzed by the analytic and feedback module and stored. User analytics and feedback collected by the module may be obtained for any purpose; however, in one or more specific examples of embodiments, such information is related to marketing and advertising programs.

As indicated, the software system functions to integrate alphanumeric data and user-driven non-alphanumeric content. Accordingly, in one non-limiting example, the software system is provided as an editor to allow users to combine alphanumeric data and user-driven non-alphanumeric content. The software system also functions to retrieve the user-driven non-alphanumeric content from a repository, along with other data, for example metadata, that can be used to make the user-driven non-alphanumeric content available to users in various ways.

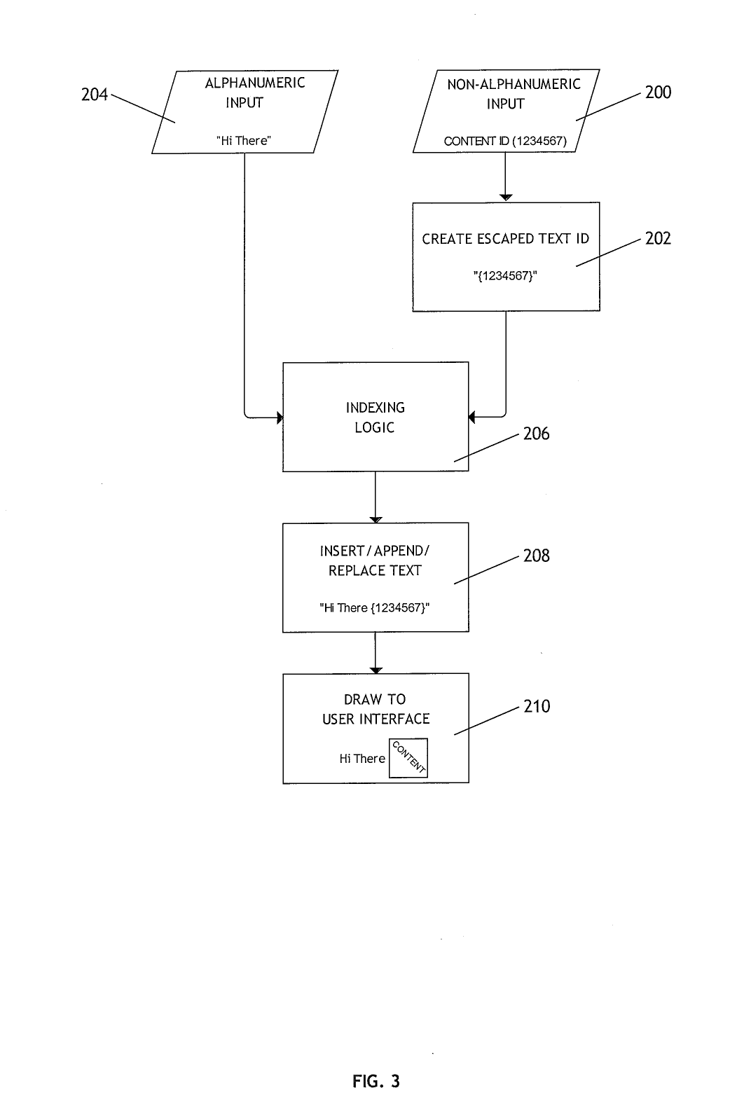

FIG. 3 illustrates one or more examples of an editing module or logic used by the system described herein to integrate alphanumeric data inline with user-driven non-alphanumeric content. In one or more examples of embodiments, non-alphanumeric input 200 is provided to, or uploaded to, the system and associated with, or assigned, a unique identifier, such as a content identification. An escaped text identification 202 is then created for the content identification. The escaped text identification 202 is indexed with alphanumeric data input 204 using indexing logic 206. Text is subsequently inserted, appended or replaced 208, and the combined alphanumeric data with inline user-driven non-alphanumeric content are displayed on, or more specifically drawn to, the user interface 210 whereby the content identification is converted to the associated user-driven non-alphanumeric content input for that identification.

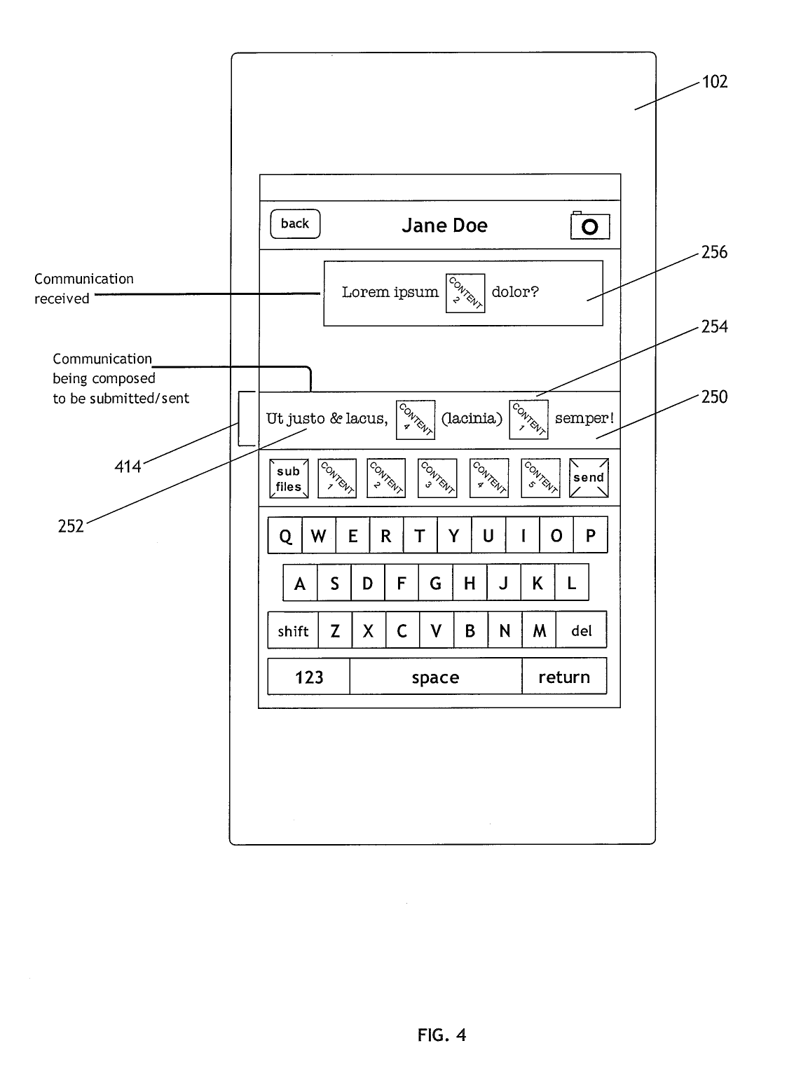

As a result of the integration, alphanumeric data is displayed with inline user-driven non-alphanumeric content in a communication. FIG. 4 shows a screen shot of a portable electronic device 102 implementing the software system and devices described herein, showing an example of a communication 250 being composed having alphanumeric data 252, namely text, displayed with inline user-driven non-alphanumeric content 254. More specifically, FIG. 4 shows an illustrative conversation using the software and system, including alphanumeric data integration with inline user-driven non-alphanumeric content, and shows a display having a received communication 256 along with a communication being composed 250 to be submitted/sent.

In one or more examples of embodiments, the software or system may be provided with a predictive content function. As an illustrative example, a user may enter one or more preselected keys or a predetermined combination of such keys on a data-entry device, such as a qwerty keyboard or the keyboard interface described in greater detail herein below. The entry of such keys results in the insertion and display of a linked data item from the user-driven non-alphanumeric content without the user's selection of that data from a menu, or for example, keying the data item for selection on the keyboard interface. In other words, based upon user action or a predetermined action, the predictive content system predicts which user-driven non-alphanumeric content should be inserted into a communication. The predetermined actions or criteria for prediction may be preselected and stored by the communication system for later comparison and use, and/or the predetermined actions or criteria may be selected by a user or learned by the system in response to user behavior.

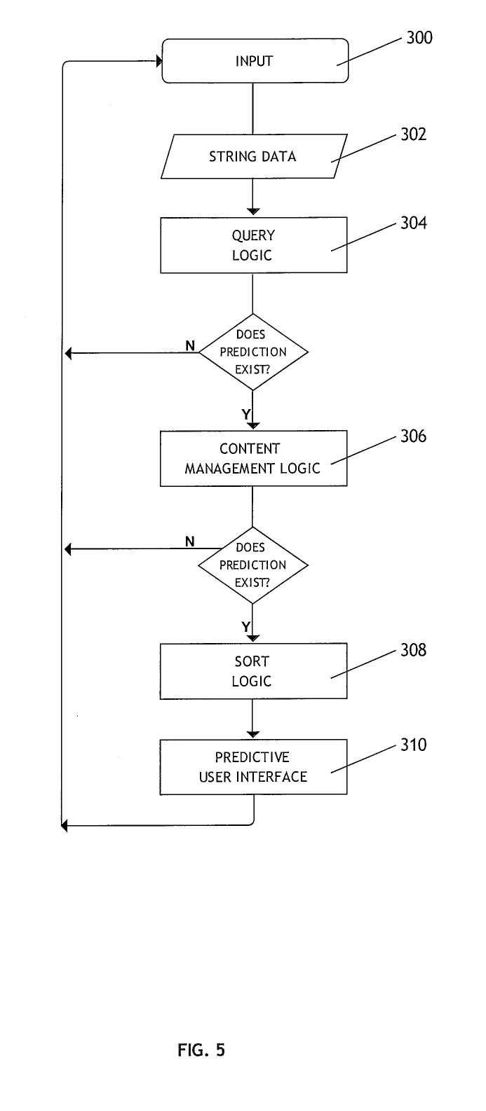

One or more examples of implementation of predictive content functionality are shown in FIG. 5. As can be seen in FIG. 5, the system receives an input 300, examples of which include keyed input or voice, for the selection of user-driven non-alphanumeric content. The input 300 is linked to corresponding string data 302. Using query logic 304, the system first determines whether a predictive link exists. Any suitable query logic may be used and customized for implementing the system, and may be established by, defined by, and/or implemented by or for the particular platform on which the communication system is used. For example, algorithm-based matching of a portion of the string or fuzzy matching may be used. In an alternative example, a more customized system may be used (e.g., associating one or more terms with a particular content element). If a link does not exist, additional input may be required by the user to complete the data entry. If a link does exist, content management logic 306 may be applied to the input. Using content management logic 306, the system determines whether a prediction exists. If a prediction does not exist, then additional input is required by the user to complete the data entry. If a prediction does exist, then sort logic 308 is applied to the input to determine which user-driven non-alphanumeric content should be displayed in response to the input. Sort logic may also be customized for the particular platform on which the communication system is used. Any suitable parameters acceptable for implementing the system may be used for sort logic (e.g., illustrative examples of which include, but are not limited to, sorting alphanumerically, sorting by trend, pushing content based upon predetermined criteria to the top of the sort, and the like). A predictive user interface 310 displays and/or inserts the predicted user-driven non-alphanumeric content for the user inline with other input, examples of which include keyed input or voice.

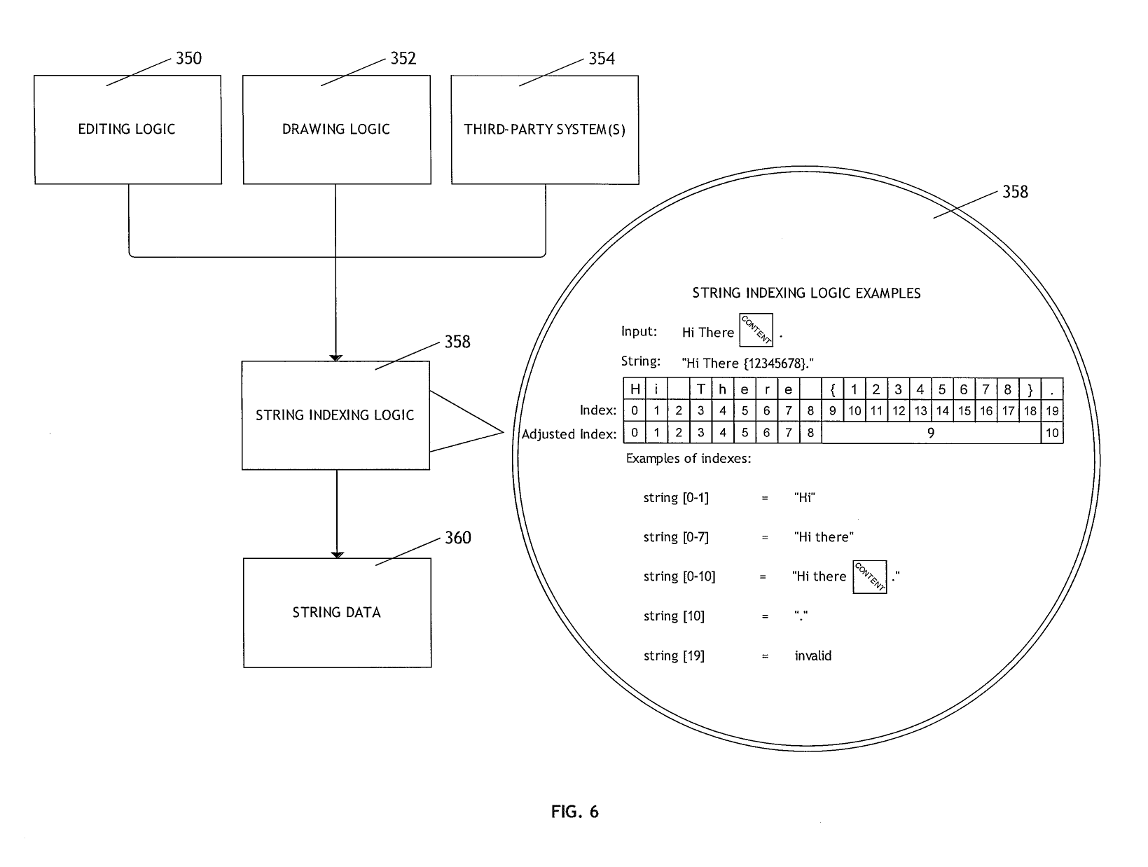

As shown in FIG. 6, in one or more examples of embodiments, additional tools may be provided to the user in association with the display of alphanumeric data with inline user-driven non-alphanumeric content. In this regard, the system described herein may integrate with one or more third-party system(s) 354, such as a third-party application programming interface (“API”) and/or other technology (e.g., spell check is an illustrative example of a third-party alphanumeric API which may be implemented by a user/client device; however, a variety of different applications may be used). In the example shown in FIG. 6, the third-party system 354 or API is integrated into the communication system using string indexing. As can be seen in FIG. 6, the third-party system 354 may be implemented on the user device along with other communication system technologies, such as editing logic 350 and drawing logic 352—each of which may be a consumer of the string indexing system 358—to subsequently display the string data 360.

The software system and integrated keyboard interface, or data selection device, implement the system on a portable electronic device. The software system and keyboard interface function to integrate alphanumeric data with user-driven non-alphanumeric content to form the cyber language. As indicated above, the software system is provided as an editor to allow users to combine alphanumeric data and user-driven non-alphanumeric content or data. FIGS. 2, 3, 5, and 6 described above illustrate various logic or flow diagrams of the content management and editing system. The data selection device or keyboard is a user interface or keyboard interface which controls the input and editing of data. The data selection device or keyboard interface functions to allow users to select, create, and file user-driven non-alphanumeric content, as well as to place it inline with alphanumeric data selected using a qwerty keyboard, so as to communicate using the system described herein.

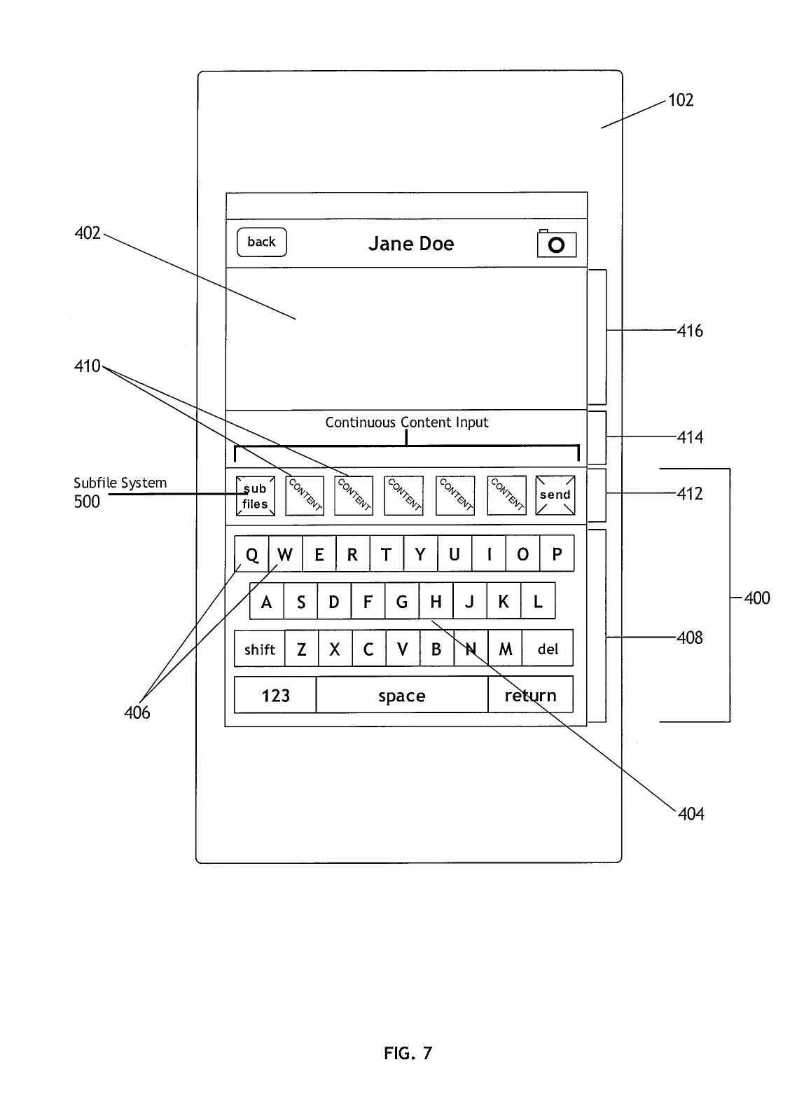

Referring to FIG. 7, the keyboard interface 400 or data selection device is shown for use with a portable electronic device having a display 402. As shown in FIGS. 4 and 7, the display includes a selected data display area or field 414, in which selected alphanumeric data and selected user-driven non-alphanumeric content, or a communication 250 (FIG. 4), are displayed. The display also includes, in one or more examples of embodiments, an area 416 for the display of one or more received and sent communications.

The keyboard interface 400 has a plurality of inputs or keys. The keyboard interface may form a portion of the display 402 or may be a distinct input or data selection area on the device or may be a distinct data selection device. The keyboard interface includes a qwerty keyboard 404 having selection keys 406 associated with alphanumeric data in a qwerty arrangement in a first area 408. A plurality of inputs 410 including user-driven non-alphanumeric content are provided in a second area 412 of the keyboard interface. The second area 412 is accessible or displayed simultaneously with the first area of the interface. As shown in FIG. 7, the second area 412 is positioned above the first area 408.

Less than all of the plurality of inputs 410 including user-driven non-alphanumeric content are displayed simultaneously on the keyboard interface 400, but the display of the plurality of inputs 410 including user-driven non-alphanumeric content is changeable or movable by a movement of the displayed plurality of inputs relative to the first area 408. Accordingly, the keyboard interface 400 features a uniquely designed continuous content input function which allows users to select, create, and file user-driven non-alphanumeric content. The continuous content input is a changeable display which provides the function or appearance of movement of the plurality of user-driven non-alphanumeric content inputs across the keyboard interface by continuous movement. In other words, the position of the visible plurality of inputs 410 shown in the second area 412 is changeable relative to the qwerty arrangement of keys in the first area 408, and the continuous content input may be a continuous keyboard such that the selection of inputs or content may be changed or replaced by movement of the existing/visible inputs, or a portion thereof, off of the visible display. In FIGS. 4 and 7, the second area 412 is laterally changeable relative to the position of the qwerty arrangement in the first area 408 which, in connection with user action, provides the appearance of continuous movement, laterally, of the visible plurality of inputs across the displayed area, the movement of one or more visible input(s) or a portion thereof to a non-visible location, and the movement of one or more input(s) or a portion thereof to a visible (or newly visible) location.

While specific examples of the location and movement of the keyboard interface and continuous keyboard are described herein, variations thereon would not depart from the overall scope of the present invention. For example, the user-driven non-alphanumeric content keyboard or continuous keyboard may also be horizontally and/or vertically continuous or movable. Likewise, while a single row of user-driven non-alphanumeric content is illustrated in the Figures, more than one row may be provided which are jointly or independently movable.

In one or more examples of embodiments, the keyboard interface or data selection device may also or alternatively include voice command integration in which data is selected and input in response to audio clues or commands. To this end, the portable electronic device may be equipped with a microphone and software capable of voice recognition and response thereto.

In one or more examples of embodiments, a user customizable keyboard interface or data selection device is further provided, in which the user may select any user-driven non-alphanumeric content (e.g., images, graphics, pictures, logos, custom graphics, video and audio data, etc.) to insert into the keyboard interface, and in particular into the continuous content input in the second area 412. As a result, user selected content or other identifiers are presented, and/or accessible on the keyboard.

In one or more examples of embodiments, an algorithm-designed function may also be provided which files any number, or a variable number, of digital content elements which are selected based upon predetermined criteria. This allows users to conveniently select and create messages with preselected user-driven non-alphanumeric content ready for immediate insertion or selection.

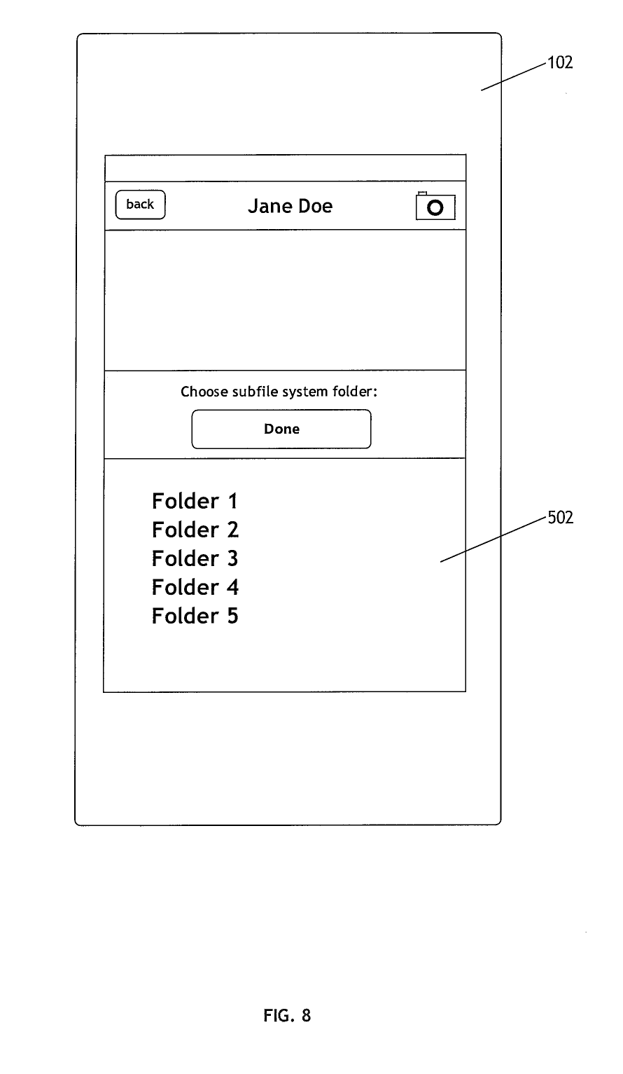

User-driven non-alphanumeric content may also be retrieved from a subfile system. In one or more examples of embodiments, as can be seen in FIGS. 4 and 7 a subfile selection key 500 may be provided on or near the continuous keyboard, either as a stationary component of the keyboard interface or movable with the continuous keyboard. As shown in FIG. 8, one or more subfiles may be selected for the local storage and categorization of user-driven non-alphanumeric content. To this end, a subfile selection key 500 may be provided on the keyboard interface (FIG. 7), the selection of which results in the display of a subfile menu 502. The menu 502 includes subfile selections which provide access to or display of one or more subfiles containing user-driven non-alphanumeric content.

User-driven non-alphanumeric content may also be collected or captured and immediately used, for example, in connection with an image forming or capturing device on the portable electronic device. In this regard, the image forming or capturing device may obtain an image. The image obtained may be displayed as non-alphanumeric content on the user device. For example, a captured image may be displayed in the continuous content input (discussed in greater detail herein) or elsewhere on the display for selection and use in a communication.

One or more representative examples of embodiments of the method for implementing the systems and devices will now be described in reference to the Figures. A method for the display of integrated data is disclosed. The method includes providing software operated on a user device having a display and in communication with a communication network(s). The device may be a portable electronic device. The software is in communication with systems for storage, receipt, display, and submission of alphanumeric data and user-driven non-alphanumeric content. The method also includes obtaining user-driven non-alphanumeric content, and operating the user device to implement the software so as to display alphanumeric data with inline user-driven non-alphanumeric content in a software application operated by the user device.

In one or more examples of portable electronic devices, the keyboard interface may be activated using the user/client device keyboard selection or activation function. More specifically, when a user selects the appropriate data field on the display or screen, this action activates the continuous content input function and causes the keyboard interface to appear for use by the user.

Once the keyboard interface is activated, a user selects keys and/or inputs to form or compose a communication. In connection with forming a communication, a user selects both alphanumeric data and user-driven non-alphanumeric content for display. FIGS. 4 and 7 show screen shots of a portable electronic device implementing the software system and devices described herein and illustrating the keyboard interface which may be used to select data and/or content. Alphanumeric data may be selected by use of a qwerty keyboard, while user-driven non-alphanumeric content may be selected using the continuous content input or accessed and obtained using the subfile folder or other linked connection to content.

User-driven non-alphanumeric content is personal to the user. According to one or more examples of embodiments, master files store a user's personally selected content which has been previously loaded by the user. Subfiles of each respective master file may also be provided to allow a user to store additional user-driven non-alphanumeric content. In one or more examples of embodiments, a user may obtain content from a server or create content locally on the user's device. This content may be stored locally or retrieved from a remote location. In one or more further examples of embodiments, content may have been previously stored on the server and downloaded to the local environment. For instance, at login remotely stored content may be downloaded to the local environment.

As indicated, user-driven non-alphanumeric content can be obtained in a variety of ways. User-driven non-alphanumeric content may be obtained by accessing a content database having user-driven non-alphanumeric content, then selecting (and storing) user-driven non-alphanumeric content. In one or more alternative examples of embodiments, user-driven non-alphanumeric content may be obtained by using an image forming or capturing device (and subsequently stored) so as to capture user-driven non-alphanumeric content.

If desired, the content obtained may be stored, and therefore retrieved from one or more files or categories, as described, which segment or segregate the content according to user preferences or according to commonalities between the respective content.

Obtained user-driven non-alphanumeric content (e.g., stored content or user-driven non-alphanumeric content designations) is displayed on the keyboard interface for use, insertion, and/or retrieval. In the illustrated example, once displayed, the continuous content input may be manipulated, continuously moving the keys or content in the continuous content input or keyboard relative to the alphanumeric display to change the options for selection of user-driven non-alphanumeric content.

A user then selects user-driven non-alphanumeric content for use. In one example, the user selects content using a continuous content input(s). The selection of content inserts the content into the text, displaying inline with the alphanumeric data of the communication. The communication is then sent via the device's or user's selected communication medium to a recipient for display on the recipient's device.

### EXAMPLE

The following presents an illustrative example of implementation of one or more embodiments of the system, method, and devices described herein. For purposes of illustration, one example of a possible structure available for use in association with the technology described herein is discussed in further detail below.

An electronic product that is a cyber language, such as the integrated system, method, and keyboard interface, is offered as an app with website integration for portable electronic devices, personal computers, and other digital devices, but is uniquely adapted for use with other applications used within their existing framework, as well as with other server-based devices. These platforms may be directly associated with the communication system or may be linked platforms through various available arrangements, such as a trade licensing distribution agreement (“TLDA”) (FIG. 1).

The communication system, methods, and devices described herein provide various advantages and opportunities over existing systems, methods, and devices.

According to one or more examples of embodiments, a cyber language is provided which uniquely integrates alphanumeric data with inline user-driven non-alphanumeric content using a data selection device or keyboard interface. More specifically, the software system facilitates a display of the integrated data (e.g., the “view” or appearance of the alphanumeric data with inline user-driven non-alphanumeric content).

The cyber language and system also provides a social communication platform that is uniquely user-driven in that it allows users to use user-driven content or user-driven non-alphanumeric content in describing or discussing their everyday digital lifestyles. Users freely share personal identification profiles by creating or selecting their user-driven content or user-driven non-alphanumeric content. The use of inline user-driven non-alphanumeric content allows a user to communicate with others via electronic means using fewer characters to express the same message. Therefore, there are no restrictions or limitations on the characters users can use to communicate via the system.

Moreover, the continuous content input or keyboard interface allows users to interact with the system. It allows users to select and use user-driven non-alphanumeric content or data on the same screen as the alphanumeric keyboard, and without, for example, going to a separate keyboard (e.g., on a separate page) or losing the alphanumeric keyboard or losing the continuous content input or going to subfiles to retrieve the content.

Unlike emoticons which use Unicode alphanumeric text, the user-driven non-alphanumeric content is not text. Instead, it may contain any type of data, encoded in binary form. Moreover, unlike the emoticons which are preloaded for use, non-alphanumeric content as described herein is user-driven. As a result, any content may be selected and communicated by the user. Accordingly, non-alphanumeric content options, and therefore options for communication, are infinite and may be continuously updated or changed.

Various commercial opportunities also exist. For instance, opportunities exist to monetize the input and use of non-alphanumeric content, as well as access to the system by an operator or implementer of the communication system.

In one or more examples of embodiments, user-driven non-alphanumeric content may be made available through TLDA 106 (FIG. 1), as well as other applications including, but not limited to, value-added arrangements, such as marketing, research, and other metrics. One or more additional advantages associated with the use of inline user-driven non-alphanumeric content is it allows for users to communicate using personal content as well as brands, thereby providing new markets for entities to raise awareness of themselves and their products. For example, non-alphanumeric content may be supplied by a company or individual and distributed in a closed-loop network. Company or individual content may also be provided in association with or communicated with/coupled to a variety of other tools, such as a link, coupon, phone number, offer, or other useful information, such that the content may have a commercial or social value for the originator of the content. As a result of this association, if a user selects the linked content, the content and associated information are placed inline in the cyber language which is communicated by the user. A recipient views this content, but also may select the associated information, providing a very direct and targeted communication.

In addition to the foregoing, analytics 120 (FIG. 1) may be linked to the system, such as within the closed-loop network, and as a result, may have valuable data which can be used for a variety of purposes.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes, and omissions may be made in the design, operating conditions, and arrangement of the various examples of embodiments without departing from the spirit or scope of the present inventions.

Moreover, some portions of the detailed descriptions herein are presented in terms of procedures, steps, logic blocks, processing, and other symbolic representations of operations on data bits that can be performed on computer memory. These descriptions and representations are the means used by those skilled in the data-processing arts to most effectively convey the substance of their work to others skilled in the art. A procedure, computer-executed step, logic block, process, etc. is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It should be borne in mind; however, that all of these and similar terms are to be associated with the appropriate physical quantities and are merely convenient labels applied to these quantities. Unless specifically stated otherwise as apparent from the discussions herein, it is appreciated that throughout the present invention, discussions utilizing terms, such as “receiving,” “sending,” “generating,” “reading,” “invoking,” “selecting,” and the like, refer to the action and processes of a computer system, or similar electronic computing device, including an embedded system, that manipulates and transforms data represented as physical (electronic) quantities within the computer system.

While this invention has been described in conjunction with the examples of embodiments outlined above, various alternatives, modifications, variations, improvements, and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements, and/or substantial equivalents.

1. A system for communicating over a communication network, the system comprising:
software operated on a user device in the communication network, the software adapted to store, receive, display, and send or submit alphanumeric data and user-driven non-alphanumeric content;
a means to obtain said user-driven non-alphanumeric content;
a storage system for the storage of data, including said user-driven non-alphanumeric content, said storage system in communication with the software on the user device;
a data selection area on the user device and in communication with the software for selection of alphanumeric data and selection of user-driven non-alphanumeric content for display;
a display on the user device for the display of the alphanumeric data and the user-driven non-alphanumeric content, the display in communication with the software on the user device, said software being adapted to display the alphanumeric data with inline user-driven non-alphanumeric content in a software application operated by the user device, and being adapted to communicate and receive the alphanumeric data and user-driven non-alphanumeric content over the communication network for display.

2. The system of claim 1, wherein the user device is a portable electronic device.

3. The system of claim 1, wherein the user-driven non-alphanumeric content comprises digital content.

4. The system of claim 1, further comprising applying predictive content functionality to insert user-driven non-alphanumeric content into the display.

5. The system of claim 1, wherein the user-driven non-alphanumeric content is content personal to a user.

6. The system of claim 1, wherein the means for obtaining user-driven non-alphanumeric content comprises a communication link to a content database having user-driven non-alphanumeric content, wherein the software is in communication with the content database for selection and storage of user-driven non-alphanumeric content.

7. The system of claim 1, wherein the means for obtaining user-driven non-alphanumeric content comprises an image forming or capturing device, wherein the software is in communication with the image forming or capturing device for storage of user-driven non-alphanumeric content obtained by the device.

8. A method for the display of integrated data, comprising:
providing software operated on a user device having a display and in communication with a communication network, said software in communication with systems for storage, receipt, display, and submission of alphanumeric data and user-driven non-alphanumeric content;
obtaining user-driven non-alphanumeric content; and
operating the user device to implement the software so as to display the alphanumeric data with inline user-driven non-alphanumeric content in a software application operated by the user device.

9. The method of claim 8, wherein the user device is a portable electronic device.

10. The method of claim 8, wherein the user-driven non-alphanumeric content is content personal to a user.

11. The method of claim 8, wherein obtaining user-driven non-alphanumeric content comprises accessing a content database having user-driven non-alphanumeric content, selecting and storing user-driven non-alphanumeric content.

12. The method of claim 8, wherein obtaining user-driven non-alphanumeric content comprises forming or capturing user-driven non-alphanumeric content with an image forming or capturing device, and storing of the user-driven non-alphanumeric content obtained by the device.

13. A keyboard interface for a portable electronic device having a display, the keyboard interface comprising:
a plurality of keys including alphanumeric data in a qwerty arrangement in a first area;
a plurality of inputs including user-driven non-alphanumeric content in a second area, the second area being accessible simultaneously with the first area, wherein less than all of the plurality of inputs including user-driven non-alphanumeric content are displayed simultaneously, and the display of the plurality of inputs including user-driven non-alphanumeric content is changeable by a movement of the displayed plurality of inputs including user-driven non-alphanumeric content relative to the first area.

14. The keyboard interface of claim 13, wherein the plurality of inputs including user-driven non-alphanumeric content is a continuous keyboard.

15. The keyboard interface of claim 13, wherein second area is positioned above the first area.

16. The keyboard interface of claim 13, wherein the plurality of inputs including user-driven non-alphanumeric content in the second area is laterally changeable relative to the position of the qwerty arrangement in the first area.

17. The keyboard interface of claim 13, wherein the user-driven non-alphanumeric content is digital content.

18. The keyboard interface of claim 13, further comprising a subfile system adapted to access additional user-driven non-alphanumeric content.

19. The keyboard interface of claim 13, wherein the display further comprises a selected data display area, in which selected alphanumeric data and selected user-driven non-alphanumeric content are displayed.

20. A portable electronic device having the keyboard interface of claim 13.
